(19) United States
(12) Patent Application Publication
(10) Pub. No.: US 2020/0270072 A1
(43) Pub. Date: Aug. 27, 2020

(54) Gripping and handling device for pallets and for layer pads for palletized loads and relative methods

(71) Applicant: Bema S.r.l., Viano (Reggio Emilia) (IT)

(72) Inventor: Gianluca Sforacchi, Viano (Reggio Emilia) (IT)

(21) Appl. No.: 16/646,365

(22) PCT Filed: Sep. 11, 2018
(86) PCT No.: PCT/IB2018/056931

§ 371 Date: Mar. 11, 2020

(30) Foreign Application Priority Data
Sep. 11, 2017 (IT) 102017000101543

(51) Int. Cl. B65G 47/91; B65G 47/90; B65G 57/00; B65G 57/04; B65G 57/24; B65G 59/04

(52) U.S. Cl. CPC B65G 47/918; B65G 47/905; B65G 57/005; B65G 2203/0233; B65G 57/24; B65G 59/04; B65G 2201/0267; B65G 57/04

(57) ABSTRACT

A device for gripping and handling pallets and/or layer pads, is provided with an attachment flange for a multiple axis movement mechanism, for example a robot of anthropomorphic type or Cartesian type, including a first anti-collision safety group, fixed to the attachment flange, with a device for detecting the vertical position of the pallet and/or of the layer pad to be picked up; a second group, connected to the first group, for the gripping, centering of the pallet and/or of the layer pad and with safety function with regard to accidental pallet falls, with a first section for gripping the pallets, for centering the pallets and/or the layer pads, and a second section for gripping the layer pads; and a control unit for supervising and controlling the functions of the device itself. Methods for gripping a pallet and/or a layer pad which use the device are also provided.

### TECHNICAL FIELD OF THE INVENTION

The present invention regards a device for gripping and handling pallets and/or layer pads, i.e. paper or plastic sheets for example, to be arranged beneath or in an intermediate position in palletised loads. Furthermore, relative methods for changing and positioning the pallets and/or layer pads are also presented.

In particular, the present invention regards a gripping and handling device that is fixed to a multiple axis movement mechanism for example a robot of the anthropomorphic or Cartesian type.

### STATE OF THE PRIOR ART

In the automated packaging industry, it is important to be able to position the pallet precisely with respect to the load, the protection layer pads on the pallet and between one layer and the other of the load and also be able to change the pallet and the relative positioning for a new load of products quickly, especially with the aim of obtaining a subsequent wrapping step that is stable and can be obtained in quick times. Furthermore, if the palletised product is quite light, there also arises the need of having to superimpose two palletised loads one on the other.

The latter function is required especially in the paper industry, but possibly in other industries too, for example foodstuffs, etcetera.

These industries require quite low palletised loads, with heights of about 1100-1200 mm., and given that the loading compartments of the delivery trucks—with a lowered loading deck—are generally more than 2400 mm. high, the two palletised loads must be superimposed one on the other to obtain a good exploitation of the loading space.

Besides the device for palletising products on the pallet, which is generally a robot, in plants of the known type a pallet discharger or dispenser is usually provided, which can also pick up and add the layer pads, a pallets or layer pads centering device for positioning the pallets or layer pads precisely; a device is also provided for superimposing pallets of palletised loads, i.e. a device that allows to superimpose two pallets of palletised loads in the palletisation area.

Thus, these devices determine a given overall dimension on the palletisation line. Besides this, times are slow due to the sequence of operations required to form the palletised load.

As a matter of fact, the operating sequence provides for picking up a pallet using the pallet discharger or dispenser device, centering the pallet using the pallets or layer pads centering device, picking up the centered pallet once again and depositing it in the palletised load forming position, picking up a layer pad using the pallet discharger or dispenser device which is used to pick up the layer pad in this case, centering the layer pad using the pallets or layer pads centering device, picking up the centered layer pad once again and depositing it in the palletised load forming position by inserting the layer pads on the pallet and between one layer and the other of the load during the formation of the palletised load. Layer pads previously centered manually by an operator can be possibly arranged, but the intervention of an operator is required in this case, and thus the layer pad centering step can be skipped.

Lastly, to form a group of two superimposed loads, there arises the need to wait for the formation of two palletised loads and then superimpose them using the pallet superimposing device.

As observable, the entire sequence is rather tedious, slow and requires engaging various devices, thus increasing the overall dimensions on the line, same case applying to the possible manual intervention of an operator who is required arrange the layer pads in a centered manner.

Patent application n. US2015/0063970A1, describes an equipment for the palletisation of a plurality of objects according to the preamble of claim 1.

The equipment of the patent application n. US2015/0063970A1 comprises: a system for transporting and arranging a plurality of objects to form an arranged set of objects; a movement system consisting of a support column on which a first movement member—suitable to move the arranged set of objects from an unloading position of the transportation and arrangement system to a pallet arranged on a work station—is moveably arranged together with a second movement member suitable to move a pallet from a stack of pallets to the work station and/or a cardboard layer pad from a respective stack to the work station. In the equipment illustrated in US2015/0063970A1, the pallets and the layer pads are arranged in previously centered stacks and thus it is necessary to provide for the centering of the pallets and layer pads using other centering devices or manually. Thus, there arises the need for additional space for the devices for centering the pallets and layer pads or there arises the need for the presence of operators for manual centering, with an extension of the operating tines and an increase of costs due to additional manpower.

### SUMMARY OF THE INVENTION

The present invention has the objective of improving the state of the art.

In this technical context, providing a device for gripping and handling pallets and/or layer pads that allows overcoming the aforementioned drawbacks is an object of the present invention.

Another object of the present invention is to provide a device for gripping and handling pallets and/or layer pads that can combine several functions in a single device and that is the quickest possible with respect to the devices of the known type.

This task and these objects are achieved by the device for gripping and handling pallets and/or layer pads according to the present application and by the methods according to the present application.

The dependent claims refer to preferred and advantageous embodiments of the invention.

### BRIEF DESCRIPTION OF THE DRAWINGS

The characteristics of the invention will be clearer to any man skilled in the art from the following description and from the attached drawings, provided by way of non-limiting example, wherein:

FIG. 1 is a perspective view of the device for gripping and handling pallets and layer pads according to the present invention;

FIG. 2 is a perspective view of the device of FIG. 1 with some parts removed for greater clarity;

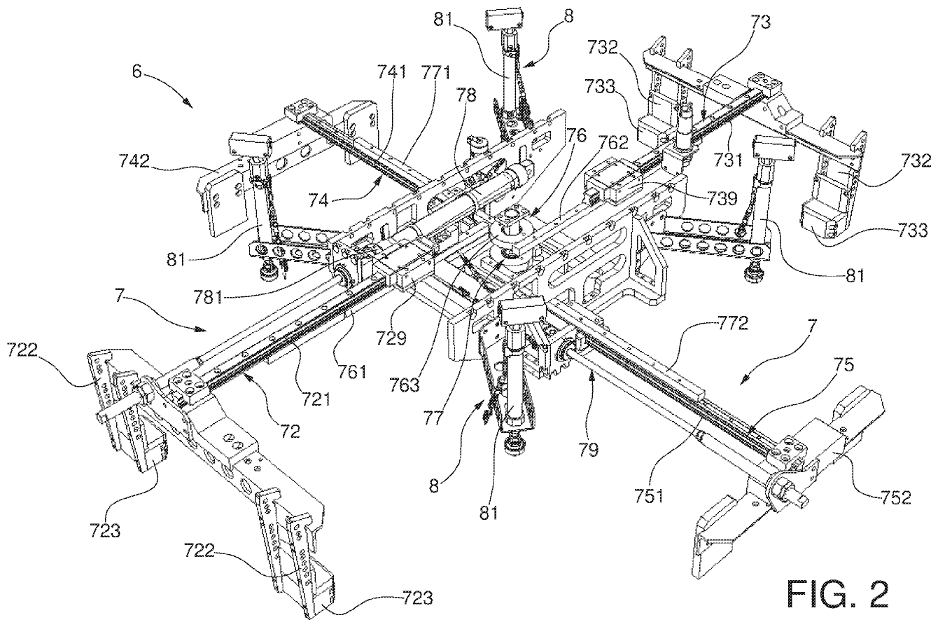

FIG. 3 is a perspective view of some details of the device subject of the preceding figures; and

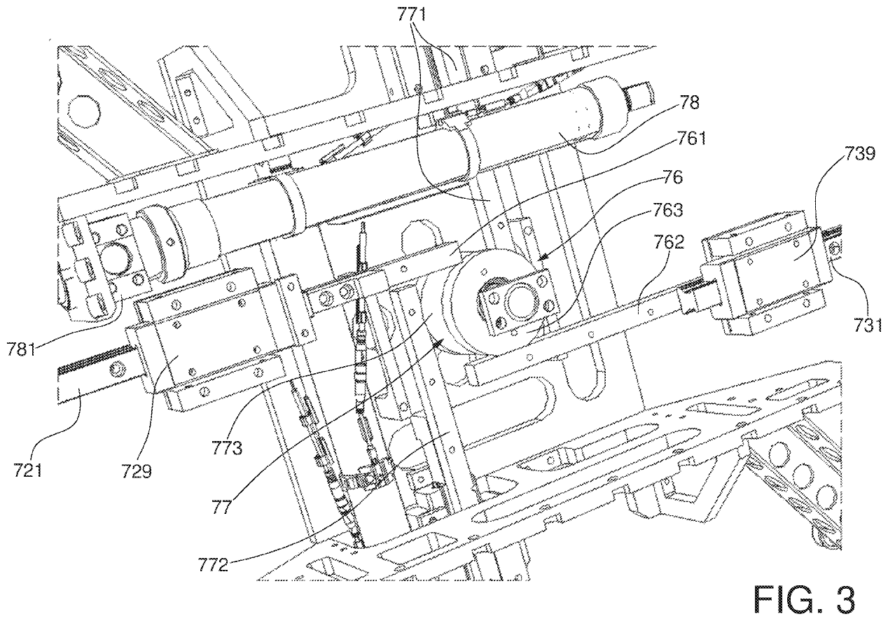

FIG. 4 is an exploded perspective view of the device for gripping and handling pallets and layer pads according to the present invention.

### DETAILED DESCRIPTION

With reference to the attached figures, the device for gripping and handling pallets and/or layer pads, according to the present invention is indicated in its entirety with 1.

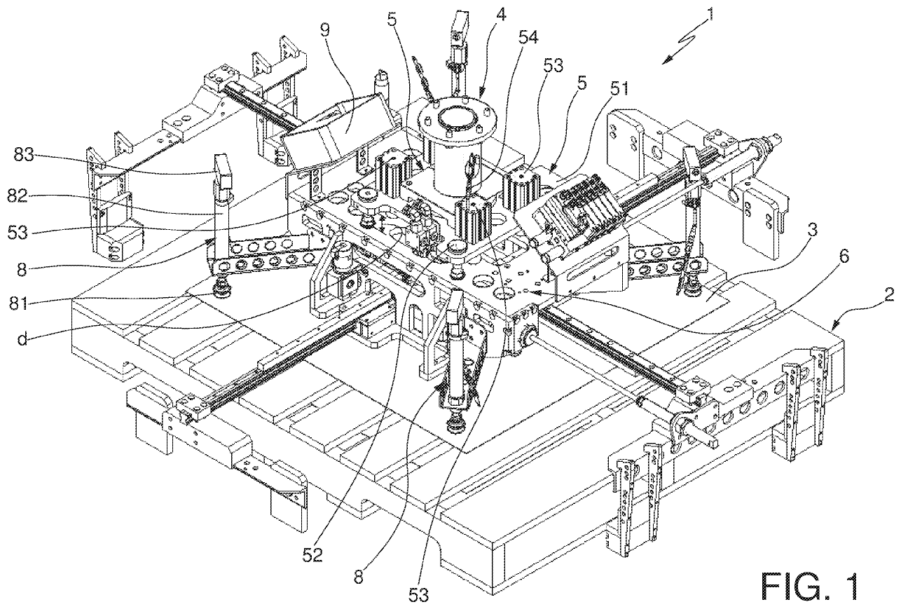

FIG. 1 illustrates a pallet 2 and layer pad 3 which are not part of the device 1 and which are gripped and handled by the device 1 as better clarified hereinafter. The device 1 is provided with an attachment flange 4 for a multiple axis movement mechanism (not illustrated), for example a robot of the anthropomorphic or Cartesian type.

The device 1 for gripping and handling pallets and layer pads, according to the present invention, essentially comprises:

a first anti-collision safety group 5, fixed to the attachment flange 4, with means for detecting the vertical position of the pallet and/or of the layer pad to be picked up;

a second group 6, connected to the first group 5, for the gripping, centering of the pallet and/or of the layer pad and with safety function with regard to accidental pallet falls, essentially comprises a first section 7 for gripping the pallets, for centering the pallets and/or the layer pads, and a second section 8 for gripping the layer pads; and

a control unit 9 for supervising and controlling the functions of the device 1. The first group 5 comprises a support plate 51 to which the attachment flange 4 is fixed, the control unit 9 and connection means 52 for connecting the first group 5 to the second group 6 maintaining the possibility of a certain movement between the two groups 5 and 6, according to a substantially vertical axis Z.

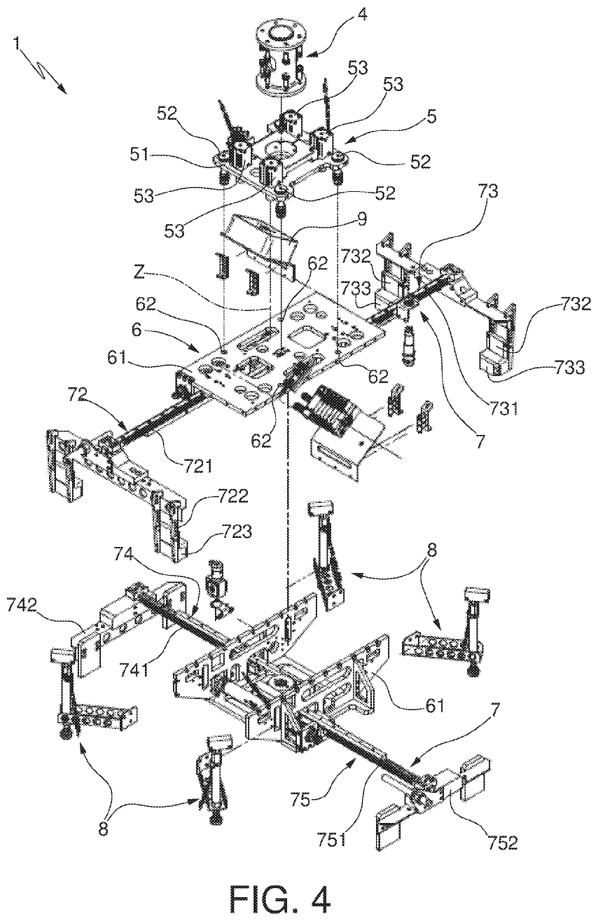

In the embodiment illustrated in the figures, the connection means between the first group 5 and the second group 6 provide for a given number of holes arranged on the plate 51 at a given distance one from the other, and within such holes a corresponding number of pins 52 are slidably arranged, provided on the upper end of a head with greater diameter of the holes, while in the lower end the pins 52 are fixed in corresponding holes 62 that are located in the underlying second group 6 (FIG. 4).

Furthermore, the first group 5 comprises elastic elements 53, which keep the second group 6 pressed moving away—at a predefined distance “d”—from the first group 5, and a certain number of end-stops 54, which detect reductions of the distance “d”, arranged on the plate 51 in proximity of the pins 52 or elastic elements 53.

Should, for any reason, the second group 6 draw near to the first group 5, each of the end-stops is capable of detecting the reduction of the distance “d”.

Should only some of the end-stops detect the reduction of the distance “d”, for example should the movement of the second group 6 be oblique with respect to the first group 5, this could mean that some part of the second group 6 has collided for example with the stack of pallets or layer pads or with other objects accidentally present in the work area of the device 1.

Thus, this could be the case of faulty positioning of some pallet or layer pad in the stacks of pallets or layer pads, or a hazardous situation, and thus the control unit 9 stops the displacement of the device 1 and a new displacement cycle can be possibly repeated, but only after reporting such situation to an operator.

If all end-stops detect a reduction of the distance “d”, then the movement of the second group 6 with respect to the first group 5 is only vertical, according to axis Z, and it indicates that, for example, the top part of the stack of pallets or layer pads has been touched.

In this case the group 5 serves as probe means capable of detecting the vertical position of the pallet and/or of the layer pad to be picked up.

The elastic elements can be simple acting pneumatic cylinders 53 fixed to the plate 51 with the stem thereof pressing on the second group 6 so as to maintain the heads of the pins 52 abutting against the plate 51.

The cylinders 53 can incorporate the end-stops 54, that for example can be of the magnetic type capable of detecting possible displacement of the plunger within the cylinder 53 with respect to the normal operative position with the second group 6 kept moving away from the first group 5.

In the embodiment of the figures, the pins 52, the cylinders 53 and the end-stops 54 are four arranged in a square in proximity of the corners of the plate 51, which is also substantially square-shaped.

However, it should be observed that the pins 52, the cylinders 53 and the end-stops 54, in particular the latter, can also be a number different from four.

For example, the end-stops 54 can be three arranged in the vertices of a triangle, because the three points are the minimum condition for defining a plane, or five, six, etcetera, arranged in the vertices of respective regular or irregular polygons: pentagon, hexagon, etcetera.

Furthermore, the elastic elements 53 and the end-stops 54 can be obtained differently, for example with mechanical springs and micro-switches, or other equivalent devices.

The pins 52, the elastic elements 53 and the end-stops 54 with the relative control means constitute a safety device against collisions, when only some of the end-stops 54 are actuated, and a probe device when all end-stops 54 are actuated simultaneously.

The second group 6 comprises a frame 61, to which the pins 52 are fixed in the holes 62, and which supports the first section 7 for gripping the pallets, for centering the pallets and/or the layer pads, and the second section 8 for gripping the layer pads.

The first section 7 for gripping the pallets, for centering the pallets and/or the layer pads, comprises two first slidable arms 72, 73 and two second slidable arms 74, 75 arranged substantially orthogonal to each other, i.e. with square cross configuration, two-by-two juxtaposed and mobile in a synchronised manner. The first section 7 further comprises first and second synchronisation means 76, 77, and at least two respective actuator means 78, 79.

The set of slidable arms 72-75 with the first and second synchronisation means 76, 77 constitute a centering device for centering the pallets.

The first arms 72 and 73 are arranged at the top part and comprise respective beams 721, 731 slidable in corresponding sliders 729, 739 that can in turn be fixed to the frame 61; in other words, the beams 721, 731 are slidably supported in a cantilevered manner by the respective sliders 729, 739.

The beams 721, 731 have, each in the external end thereof, at least two gripping elements 722, 732, provided with respective gripping teeth 723, 733, i.e. four gripping teeth 723, 733.

Obviously, the number of gripping teeth 723, 733 may vary as a function of the size and weight of the pallet; the aforementioned gripping teeth 723, 733 perform a gripping function similar to that of the forks of a forklift, given that they are positioned two by two so as to be inserted into the forking space provided for in the pallet.

Thus, the gripping teeth 722, 733 allow to obtain a safe gripping of the pallet, in that based on a shape constraint and not based on the gripping friction, and this allows avoiding the accidental fall of the pallet especially if the profile of the perimeter of the pallet is irregular shaped, the gripping teeth 722, 733 are thus safety means against the accidental falls of the pallet which is gripped by the gripping elements 722, 732.

The second arms 74 and 75 which, in the embodiment illustrated in the figures, are arranged substantially orthogonally beneath the first arms 72 and 73, they also comprise two respective beams 741, 751 slidable in the corresponding sliders 749, 759 which are in turn fixed to the frame 61.

It should be considered that the arrangement above and beneath these elements is purely by way of example and the arrangement of these elements can be exchanged.

The beams 741, 751 have each—in the end—at least two gripping elements 742, 752, but without a gripping tooth due to the fact that they have a centering function only.

All gripping elements and gripping teeth for the pallets are obtained with rounded or bevelled profiles to avoid jamming, especially when it comes to wooden pallets which could have defects or irregularities.

The first synchronisation means 76, which are arranged above the second synchronisation means 77, are provided to obtain the reciprocating and synchronised motion of the first arms 72 and 73, while the second synchronisation means 77 provide for obtaining a reciprocating and synchronised motion of the second arms 74, 75.

Even as concerns these elements, the above and beneath arrangement is purely by way of example and the arrangement of these elements could also be exchanged. Upon closing the first arms 72 and 73, the two gripping elements 722 and 732 are moved by the same measure and at the same time, thus attaining the centering of the pallet or the layer pad towards the center of the device 1, along a first direction corresponding to the sliding direction of the first arms 72 and 73.

Upon closing the second arms 74 and 75, the two gripping elements 742 and 752 are moved by the same measure and at the same time, thus attaining the centering of the pallet or the layer pad towards the center of the device 1, along a second direction, substantially orthogonal to the first direction, corresponding to the sliding direction of the second arms 74 and 75.

Thus, the pallet or the layer pad is perfectly centered according to two directions substantially orthogonal to each other and thus generally centered.

The first and second synchronisation means 76, 77 are independent from each other and obtained in a similar manner.

The first synchronisation means 76 comprise a mechanism with a first rack and pinion 761 fixed to the first beam 721, another first rack and pinion 762 fixed to the other first beam 731 and a first cogwheel 763—rotatably supported by the frame 61 in an idle manner—which meshes with the two rack-and-pinions 761 and 762.

The second synchronisation means 77 comprise a mechanism with a second rack and pinion 771 fixed to the second beam 741, another second rack and pinion 772 fixed to the other second beam 751 and a second cogwheel 773—rotatably supported by the frame 61 in an idle manner—which meshes with the two rack-and-pinions 771 and 772.

As can be intuited, thanks to this mechanism, when the first beam 721 moves, the other first beam 731 moves in the opposite direction by an equal measure too, and the same thing occurs for the second beams 741, 751.

The first and second synchronisation means 76, 77 can also be obtained differently, for example with levers and connecting rods or even by means of electronic devices of the linear encoder type and providing each slidable arm with a respective actuator.

The first actuator means 78 comprise a double-acting pneumatic cylinder which actuates both the first beams 721 and 731, one of which directly and the other through the synchronisation means.

Given that the first beams 721 and 731 provide for a shape gripping of the pallet through gripping teeth 722, 733 there also arises the need to be able to block the position of the beams, to provide greater safety for lifting the pallet.

To this end, the double-acting pneumatic cylinder comprises a locking device 781 on the stem, which ensures that the beams 721, 731 do not move upon lifting the pallets.

Also, the second beams 741 and 751 are actuated by the second actuator means 79 which comprise a double-acting pneumatic cylinder, in this case without the locking device given that it is not necessary to guarantee the lifting of the pallet, but just centering according to the sliding direction of the second beams 741 and 751.

The second section 8 for gripping the layer pads comprises suctioning means 81 mounted on a given number of vertical actuators 82, for example four double acting pneumatic cylinders provided with a hollow stem and magnetic end-stop indicating the fully lifted position of the plunger of the pneumatic cylinder.

The suctioning means comprise bellows-like suction cups 81 actuated in suctioning through vacuum generators 83 arranged on the upper part of the pneumatic cylinders 82 and communicating with the suction cups 81 through the hollow stem of the pneumatic cylinders 82.

The pneumatic cylinders 82 are actuated in ascent or in descent through a pneumatic circuit provided with check valves, controlled by the pressure on the descent duct, on the ascent duct, so as to maintain the raised position of the suction cup when gripping the layer pads.

It should be observed that in the device 1 according to the invention, only pneumatic actuators were used due to the fact that they are usually lighter and less expensive as compared to other types of actuators. However, the device 1 could equally work even with other types of actuators, for example actuators of the electric or oil hydraulic type.

Described below are some operating cycles of the device 1.

According to a first operating cycle which serves for gripping the pallet, the device 1 for gripping and handling is positioned with all four arms 72, 73, 74, 75 open directly over the stack of empty pallets 2 to be picked up.

The device 1 descends until it rests on the top part of the stack, obtaining—from the group 5—an operation as probe means, detecting the vertical position of the pallet 2 and being free from possible height errors on the pallets.

Once the probe means have detected the top part of the stack of pallets 2, the device 1 lifts by a pre-established height, depending on the type and size of the pallets, to allow the gripping teeth 723, 733 to be inserted into the forking space of the pallet.

So, the first arms 72 and 73 are actuated to close, and the first synchronisation means 76 allow the pallets to be centered along a first direction corresponding to the sliding direction of the first arms 72 and 73.

The teeth 723, 733 guarantee a safe gripping of the pallet even should the vertical walls of the gripping elements 722, 732 not be fully secured against the sides of the pallet. The entire device 1 lifts by an amount sufficient to allow to detach the pallet to be handled from the stack of pallets.

The first arms 72 and 73 with the relative teeth 723, 733 are moved to “neutral”, i.e., the closing force is removed and the pallet is free to be able to move laterally. However, the locking device 781 of the stem of the respective actuator 78 is also actuated so as to maintain the shape gripping on the pallet.

Due to the weight thereof, the pallet will descend and rest on the upper horizontal wall of the four teeth 723, 733 of the gripping mechanism.

Should, for any reason, the pallet not descend due to the fact that it is stuck somewhere, this does not represent a problem at this stage.

Thus, the second arms 74 and 75 are also actuated, which move the two gripping elements 742 and 752 by the same measure and at the same time, thus attaining the centering of the pallet along the second direction, substantially orthogonal to the first direction, corresponding to the sliding direction of the second arms 74 and 75.

Due to this movement, even the potentially stuck pallet descends and rests against the upper horizontal walls of the gripping teeth 723, 733, thus the pallet encounters a horizontal surface on which it can slide according to the single degree of freedom allowed thereto.

The pallet 2 is thus deposited in the position in which the load of the products to be palletised is formed, for example even above another previously palletised load.

The result of this first operating cycle is thus having a pallet centered with respect to the center of the gripping device 1 and thus allowing to move on to a subsequent operating step.

Should the pallet to be picked up from the stack of pallets be displaced beyond the maximum tolerances that can be managed by the device 1, the group 5 with the end-stop 54 detect an unusual situation, i.e., only a few end-stops 54 are actuated, and thus the operating cycle cannot be completed.

According to a second operating cycle which serves for picking up the layer pads, the gripping and handling device 1 is positioned with all four arms 72, 73, 74, 75 open directly over the stack of layer pads 3.

It should be observed that the warehouse of the layer pads 3 does not require any accessory, in particular there is no need for brushes, centering elements, etcetera. The device 1 descends until it rests on the top part of the stack of layer pads, obtaining—from the group 5—the operation as probe means capable of detecting the position of the top part of the stack of layer pads 3.

Thus, the device 1 lifts by a pre-established height which allows the gripping elements 722, 732, 742 and 752 to center a given number of layer pads 3 arranged at the topmost part.

When the first arms 72 and 73 are actuated to close, the first synchronisation means 76 allow a given number of layer pads 3 to be centered along a first direction corresponding to the sliding direction of the first arms 72 and 73.

Thus, the second arms 74 and 75 are also actuated, which move the two gripping elements 742 and 752 by the same measure and at the same time, thus attaining the centering of a given number of layer pads 3 along the second substantially orthogonal direction, corresponding to the sliding direction of the second arms 74 and 75.

At this point, a given number of layer pads 3 is fully centered with respect to the center of the device 1.

Then, the descent is actuated of the suction cups 81, which rest against the stack of layer pads 3 and the vacuum generators 83 are actuated so as to allow the topmost layer pad 3 to be attached to the suction cups 81.

All the first arms 72, 73 and the second arms 74, 75 are moved to “neutral”, i.e., the closing force is removed maintaining the achieved position.

Thus, the layer pads underlying the one to be handled, no longer having any external force besides the one of the possible low friction with the gripping elements, which are rounded and bevelled, can slide with respect to the gripping elements 722, 732, 742 and 752, which perform the guiding function only in this case.

The device 1 then lifts by a pre-established height, to allow a first detachment of the last layer pad 3 from the stack, the lifting height being large enough to allow a first detachment of the layer pad, but the terminal part towards the bottom of the gripping elements 722, 732, 742 and 752 still constitutes an enclosure for containing and guiding the layer pads immediately beneath the one to be handled, so as to prevent—during the detachment of the layer pad on the top part of the stack—the layer pad immediately beneath from flying out of the warehouse.

All the first arms 72, 73 and the second arms 74, 75 are then opened fully. The ascent of the suction cups 81 and the descent immediately thereafter is actuated as the last handling safety action.

Not having a central support, the layer pad 3 will bend partially ensuring the detachment of the possible layer pad, or the possible layer pads, attached to the layer pad at the top part of the stack and a safe pick up of a single layer pad 3 to be handled.

Thus, there is a single layer pad 3, centered with respect to the center of the device 1 and firmly gripped by means of the suction cups 81 and thus allowing to move on to the next step.

Should the stack of layer pads be displaced beyond the maximum manageable tolerances with respect to the center of the device 1, the group 5 with the end-stops 54 detects an unusual situation, i.e., only a few end-stops 54 are actuated, and thus the operating cycle cannot be completed.

Following is the description of the combined operating cycle for picking up a layer pad and a pallet centered with respect to each other and with respect to the device 1.

Firstly, the operating cycle is carried out for picking up a layer pad 3. Thus, there is a single layer pad 3, centered with respect to the center of the device 1 and firmly gripped by means of the suction cups 81, then all four arms 72, 73, 74, 75 are opened and thus all pneumatic cylinders 82 carrying the suction cups 81 are brought to the lowest height.

The device 1 with the layer pad 3 attached to the suction cups 81 is carried above the stack of pallets 2. Should the stack of pallets be displaced beyond the maximum manageable tolerances with respect to the center of the device 1, the cycle is stopped just like in the case of the previous cycles.

On the other hand, should the stack of pallets 2 be positioned within the tolerances provided for, the device 1 starts to descend towards stack of pallets, and at the same time the pneumatic cylinders 82 are moved to “neutral” position, i.e., the downward thrust force is removed.

Thus, due to the downward movement of the entire device 1, the pneumatic cylinders 82 will be thrust upward, until the probe means of the device 1 detect the top part of the stack of pallets.

The vertical height of the suction cups 81 is thus maintained by the pneumatic circuit for actuating the cylinders 82, a circuit which, as mentioned, provides for check valves on the ascent ducts of the cylinders 82, thus the suction cups 81 with the layer pad 3 attached cannot descend any more.

This is done so as to allow the pallet to be centered without having the layer pad at contact, and thus in order to avoid possible problems related to the displacement of the layer pad due to the possible sliding between the layer pad and pallet.

Then, the previously described pallet gripping operating cycle is carried out.

Once the cycle for the pallet is carried out, the layer pad 3 is centered and situated beneath the pallet 2, which is also centered. Upon providing the lowering command to the cylinders 82 of the suction cups 81, the layer pad 3 rests above the pallet 2 and the device 1 can thus move on to a subsequent operation.

It has thus been observed that the invention attains the pre-set objectives.

The device 1 according to the present invention allows reducing the time that elapses during the operations for changing the pallets and inserting the layer pad when forming a load on a pallet, to the minimum.

The device 1 has the advantage of being able to deposit the pallets and the layer pads always in the same position irrespective of the position and method for loading pallets and layer pads, the only restriction lying in the maximum opening of the arms of the device which allows the latter to be able to descend on the stacks of the pallets or the layer pads.

Furthermore, the device 1 is also capable of positioning a layer pad centered with respect to the movement mechanism above a pallet centered in turn with respect to the movement mechanism without having to necessarily rest neither the pallet nor the layer pad on a plane, thus leading to considerably saving time in the general cycle for forming a load on a pallet.

Though the present invention has been described according to preferred embodiments, equivalent variants may be conceived without departing from the scope of protection offered by the claims that follow.

1. A gripping and handling device for pallets and/or for layer pads, provided with an attachment flange for a multiple axis movement mechanism, for example a robot of anthropomorphic type or Cartesian type, comprising a group for the gripping the pallet and/or of the layer pad with a first section for gripping the pallets and a second section for gripping the layer pads and a control unit for supervising and controlling the functions of the device itself, further comprising:
a first anti-collision safety group, fixed to the attachment flange, with means for detecting the vertical position of the pallet and/or of the layer pad to be picked up;
wherein said first group comprises elastic elements, which maintain the second group pressed in moving away at a predefined distance “d” from the first group, and at least three end-stops, which detect reductions of the distance “d”, arranged on the plate at the vertices of a triangle in proximity to the connections means or elastic elements, and wherein the control unit is configured to stop the displacement of the gripping and handling device if only some of the end-stops detect the reduction of the distance “d” in the case of faulty positioning of some pallet or layer pad in the stacks of pallets or layer pads, or a hazardous situation, wherein
said group for the gripping the pallet and/or of the layer pad is a second group connected to the first group, and said group is provided with a centering device for centering the pallets and/or the layer pads, and with safety means against the accidental falls of the pallet.

2. The device according to claim 1, wherein said first group comprises a support plate to which the attachment flange is fixed, the control unit and connection means for connecting the first group to the second group, said second group comprising a frame with at least one hole, said connection means comprising at least one pin with an upper end slidable within the hole of the support plate and with a lower end connected to the frame in the at least one hole, so as to maintaining the possibility of a certain movement between the two groups, according to a substantially vertical axis Z.

3. (canceled)

4. The device according to claim 1, wherein said end stops are at least three, arranged at the vertices of a triangle, or there are at least four end stops arranged at the vertices of respective regular or irregular polygons.

5. The device according to claim 1, wherein second group comprises a frame which supports said first gripping section for the pallets, for centering the pallets and/or the layer pads, comprising two first slidable arms and two second slidable arms arranged substantially orthogonal to each other, i.e. with square cross configuration, two-by-two opposite and movable in a synchronized manner, first and second synchronization means, and at least two respective actuator means respectively for the first and the second slidable arms, wherein said first slidable arms comprise respective first beams which are projectingly supported in a slidable manner by respective first sliding blocks, which are in turn fixed to the frame, and wherein said second slidable arms comprise respective second beams which are projectingly supported by respective second sliding blocks, which are in turn fixed to the frame and wherein said first synchronization means comprise a mechanism with a first rack fixed to the first beam, another first rack fixed to the other first beam and a first toothed wheel, rotatably supported by the frame in an idle manner, which engages with the two first racks, and said second synchronization means comprise a mechanism with a second rack fixed to the second beam, another second rack fixed to the other first beam and a second toothed wheel, rotatably supported by the frame in an idle manner, which engages with the two second racks.

6. (canceled)

7. (canceled)

8. The device according to claim 5, wherein said two first slidable arms comprise, in the external end thereof, at least two gripping elements, provided with respective gripping teeth, and comprising first actuator means with a double-acting pneumatic cylinder which actuates both said first slidable arms, said pneumatic cylinder being provided with a locking device.

9. The device according to claim 5, wherein said two second slidable arms comprise, in the external end thereof, at least two gripping elements, and comprising second actuator means with a double-acting pneumatic cylinder which actuates both said second slidable arms.

10. The device according to claim 1, wherein said second section for gripping layer pads comprises suction means mounted on a certain number of vertical actuators.

11. The device according to claim 10, wherein when said vertical actuators are pneumatic cylinders, said pneumatic cylinders are actuated upward or downward by means of a pneumatic circuit provided with check valves on the duct for the upward movement, the check valves being driven by the pressure on the duct for the downward movement.

12. A method for gripping a pallet which uses a device according to claim 8, comprising the steps of:
g, for the gripping, centering of the pallet and/or of the layer pad;
abutting said device against a stack of pallets, obtaining from the first group the detection of the vertical position of the highest pallet; lifting the device for a pre-established height, based on the type and size of the pallet, in order to allow gripping teeth of the second group to be inserted within the forking space of the pallet itself;
actuating the closing of the first arms of the second group, allowing—by means of the first synchronization means—the pallet to be centered along a first direction corresponding to the sliding direction of the first arms;
removing the closing force of the first arms and fixing the position reached by means of a locking device;
actuating the closing of the second arms of the second group, allowing—by means of the second synchronization means—the pallet to be centered along a second direction, substantially orthogonal to said first direction and corresponding to the sliding direction of the second arms; and
depositing said pallet in the position wherein the loading of the products to be palletized must be formed.

13. The method for gripping a layer pad which uses a device according to claim 8, further comprising the steps of:
opening the second group to the maximum opening, for the gripping, centering of the pallet and/or of the layer pad;
abutting said device against a stack of layer pads, obtaining from the first group the detection of the vertical position of the highest layer pad; actuating the closing of the first arms and second arms of the second group, allowing—by means of the first and second synchronization means—the highest layer pads in the stack to be centered along a first direction corresponding to the sliding direction of the first arms and along a second direction substantially orthogonal to the first and corresponding to the sliding direction of the second arms;
removing the closing force of the first arms and of the second arms and maintaining the attained position;
lowering suckers such that they abut against the stack of layer pads and actuating vacuum generators so as to allow the highest layer pad in the stack to be attached to the suckers;
lifting the device for a pre-established height in order to carry out a separation of the layer pad, maintaining the highest layer pads in the stack centered; and
actuating the upward movement of the suckers and immediately afterward the downward movement, in order to facilitate the separation of the possible layer pad or possible layer pads attached to the highest layer pad in the stack, and obtaining a safe pick-up only of the highest layer pad to be handled.

14. The method for gripping a layer pad according to claim 13 followed by the method for gripping a pallet according to claim 12.

15. The method for gripping a layer pad according to the preceding claim 13, wherein between the steps for gripping a layer pad and the steps for gripping a pallet, the following steps are provided:
removing the downward thrust force of the pneumatic cylinders, to which the suckers which maintain the layer pad are fixed;
moving the entire device downward, said pneumatic cylinders will be thrust upward, until the probe means of the device detect the top of the pallet stack; and
maintaining the vertical height of the suckers by blocking the pneumatic actuation circuit for the cylinders through check valves which are situated on the ducts for the upward movement of the cylinders themselves, in order to not have the layer pad in contact with the pallet and to prevent possible problems of movement of the layer pad due to the possible sliding between the layer pad and the pallet.
